(19) United States
(12) Patent Application Publication
(10) Pub. No.: US 2004/0188238 A1
(43) Pub. Date: Sep. 30, 2004

(54) System and method for concurrent particulate and NOx control

(76) Inventors: Mark David Hemingway, Columbia Ville, MI (US); David Alexander Goulette, Marine City, MI (US); Thomas Roger Thoreson, Brighton, MI (US)

Correspondence Address: VINCENT A. CICHOSZ, DELPHI TECHNOLOGIES, INC., Legal Staff Mail Code: 480-410-202, P.O. Box 5052, Troy, MI, 48007-5052, US

(21) Appl. No.: 10/402,209

(22) Filed: Mar. 28, 2003

(51) Int. Cl. B01D 53/56; B01J 19/08; B01J 19/12

(52) U.S. Cl. 204/164; 423/239.1; 422/186.07

(57) ABSTRACT

A system for concurrent particulate and NOx control in a combustion exhaust stream includes a particulate filter for trapping particulate matter in the exhaust stream; a non-thermal plasma reactor connected downstream of the particulate filter for further treating the exhaust stream; and a catalytic converter connected downstream of the non-thermal plasma reactor for reducing nitrogen oxides in the plasma treated exhaust stream. The system further includes an ozone generating device associated with but thermally insulated from the non-thermal plasma reactor for generating and discharging ozone to the combustion exhaust stream to create an ozone and NO₂ enriched exhaust stream. The ozone and NO₂ enriched exhaust stream is fed into the filter to regenerate the filter by oxidizing particulate matter trapped in the filter. The ozone generating device and the non-thermal plasma reactor are connected to a single high voltage power source thereby reducing system complexity and cost.

### TECHNICAL FIELD

The present invention relates generally to combustion exhaust treatment and more particularly relates to a system and method for concurrently treating particulate and NOx emissions in diesel engine exhaust streams.

### BACKGROUND OF THE INVENTION

Certain compounds in the exhaust stream of a combustion process, such as the exhaust stream from an internal combustion engine, are undesirable in that they are thought to produces adverse health effects and must be controlled in order to meet government emissions regulations. Among the regulated compounds are hydrocarbons, soot particulates, and nitrogen oxide compounds (NOx). There are a wide variety of combustion processes producing these emissions, for instance coal- or oil-fired furnaces, reciprocating internal combustion engines (including gasoline spark ignition and diesel engines), gas turbine engines, and so on. In each of these combustion processes, control measures to prevent or diminish atmospheric emissions of these emissions are needed.

Industry has devoted considerable effort to reducing regulated emissions from the exhaust streams of combustion processes. In particular, it is now usual in the automotive industry to place a catalytic converter in the exhaust system of gasoline spark ignition engines to remove undesirable emissions from the exhaust by chemical treatment. Typically, a “three-way” catalyst system of platinum, palladium, and rhodium metals dispersed on an oxide support is used to oxidize carbon monoxide and hydrocarbons to water and carbon dioxide and to reduce nitrogen oxides to nitrogen. The catalyst system is applied to a ceramic substrate such as beads, pellets, or a monolith. When used, beads are usually porous, ceramic spheres having the catalyst metals impregnated in an outer shell. The beads or pellets are of a suitable size and number in the catalytic converter in order to place an aggregate surface area in contact with the exhaust stream that is sufficient to treat the compounds of interest. When a monolith is used, it is usually a cordierite honeycomb monolith and may be pre-coated with gamma-alumina and other specialty oxide materials to provide a durable, high surface area support phase for catalyst deposition. The honeycomb shape, used with the parallel channels running in the direction of the flow of the exhaust stream, both increases the surface area exposed to the exhaust stream and allows the exhaust stream to pass through the catalytic converter without creating undue back pressure that would interfere with operation of the engine.

When a spark ignition engine is operating under stoichiometric conditions or nearly stoichiometric conditions with respect to the fuel-air ratio (just enough oxygen to completely combust the fuel, or perhaps up to 0.3% excess oxygen), a “three-way” catalyst has proven satisfactory for reducing emissions. Unburned fuel (hydrocarbons) and carbon monoxide are oxidized consuming relatively small amounts of oxygen, while oxides of nitrogen (NOx) are simultaneously reduced. However, it is desirable to operate the engine at times under lean burn conditions, with excess air, in order to improve fuel economy. Under lean burn conditions, conventional catalytic devices are not effective for reducing the NOx in the oxygen-rich exhaust stream.

A diesel engine has substantially lower fuel consumption than a spark ignition engine, particularly at light loads. The exhaust stream from a diesel engine also has substantial oxygen content, from perhaps about 2-18% oxygen, and, in addition, contains a significant amount of particulate emissions. The particulate emissions, or soot, are thought to be primarily carbonaceous particles and volatile organic compounds (VOC). While diesel combustion process developments have been made that successfully decrease the total mass of particulates emitted, these modifications may have actually increased the numbers of smaller nanoparticles which are a particular health concern as they can travel deep into the lungs.

In spite of efforts over the last decade to develop an effective catalyst for reducing NOx to nitrogen under oxidizing conditions in a spark ignition gasoline engine and in a diesel engine, the need for improved conversion effectiveness has remained unsatisfied. Moreover, there is a continuing need for improved effectiveness in treating emissions from any combustion process, particularly for simultaneously treating the nitrogen oxides and soot particulate emissions from diesel engines. Several techniques have been proposed to modify the exhaust chemistry enabling the use of existing catalyst technology. However, these techniques can add considerable cost and complexity to the vehicle.

One technique that has been successfully applied in large stationary applications comprises injecting urea into the exhaust stream ahead of the catalytic converter where it quickly decomposes to ammonia. The ammonia reacts with the excess oxygen in the exhaust stream, shifting the exhaust chemistry closer to stoichiometric conditions. Some of the challenges presented when using this technology include: (1) storing the aqueous urea solution onboard and preventing it from freezing under cold ambient temperature conditions; (2) correctly metering the urea solution into the exhaust (too much urea can result in ammonia emissions, too little urea can cause high NOx emissions); and (3) replenishing the urea—this requires establishing a supply network to distribute urea and customer acceptance of the expense and inconvenience in maintaining an adequate urea supply onboard the vehicle.

Another approach comprises adding a NOx adsorbent to the catalyst washcoat to adsorb NOx emissions from the exhaust stream during lean conditions. The adsorbed NOx must be periodically purged by shifting the air/fuel ratio from lean to slightly rich causing the adsorbent to release the adsorbed NOx which is reduced to nitrogen by the catalyst in the now rich exhaust stream. This technique presents significant control problems as the air and fuel rates must be simultaneously modified by the engine control system to effect the air-fuel ratio change without altering the engine load. The heterogeneous combustion diesel engine has an even more challenging additional problem of generating extremely heavy amounts of particulate emissions at air-fuel ratios near stoichiometric or rich conditions.

Particulate filters have been shown to be an effective means for controlling diesel particulate emissions. Wall flow particulate filters have been developed over the past twenty years and can be greater than 90% efficient in trapping particulate matter including nanoparticles. The principle disadvantage with particulate filters is the need to periodically regenerate the filter to remove the trapped particulate matter. Regeneration removes particulate matter from the filter by oxidizing the carbon and volatile organic compounds (VOCs) to carbon dioxide and water. This oxidation occurs spontaneously at temperatures above about 600° C. The heat released from the oxidation reactions can be substantial in a heavily loaded filter which can melt or crack the filter when regeneration occurs at low engine flow rates. Diesel exhaust temperatures are typically not hot enough to initiate spontaneous regeneration, particularly in light duty applications where exhaust temperatures may seldom exceed 200° C. Thus, a regeneration technique which is initiated at much lower temperatures and is controlled to limit the particulate filter temperature increase is required.

Catalyzing the particulate filter to lower the particulate oxidation temperature has been proposed. However, results have not been favorable due to the poor contact between the particulate mass and the catalyst.

Adding a dopant, such as cerium, to the fuel, has been shown to lower the particulate oxidation temperature. However, this approach requires adding hardware to store the dopant on the vehicle and continuously dope the fuel. Further the dopants do not reduce the regeneration temperature sufficiently to ensure particulate filter regeneration for light load engine applications such as city driving.

Another technique comprises adding a small oxidation catalyst ahead of the particulate filter to catalyze the NO in the lean exhaust to NO₂. The NO₂ acts as a stronger oxidizing agent than exhaust oxygen. This technique is passive and cleans the particulate filter whenever the exhaust temperatures are sufficient for the oxidation catalyst to effect the NO to NO₂ conversion, thus preventing buildup of particulate mass on the filter in applications with sufficient exhaust temperature. However, in light engine load applications such as city driving, exhaust temperatures are too low for this technique to operate reliably.

There is a continuing need for improved effectiveness in treating emissions from any combustion process, particularly for treating nitrogen oxide and soot emissions from diesel engines.

### SUMMARY OF THE INVENTION

A system for concurrently reducing nitrogen oxides and controlling particulate matter in a combustion exhaust stream and regenerating a diesel particulate filter comprises:

a particulate filter for treating a combustion exhaust stream including nitrogen oxides and particulate matter having an inlet for receiving the combustion exhaust stream and an outlet for discharging a particulate treated exhaust stream;

a non-thermal plasma reactor having an inlet connected to the particulate filter outlet for receiving the particulate treated exhaust stream and an outlet for discharging a plasma treated exhaust stream; the non-thermal plasma reactor being connected to a high voltage power source;

an ozone generating device, preferably a corona discharge ozone generating reactor, for generating and discharging ozone to the combustion exhaust stream, the ozone generating device having an inlet for receiving a flow of air and an outlet connected to the combustion exhaust stream upstream of the particulate filter; the ozone generating device preferably being connected to the same high voltage power source as the non-thermal plasma reactor; and an air supply for supplying air to an air inlet of the ozone generating device;

a catalytic converter having a catalyst for reducing nitrogen oxides in the plasma treated exhaust stream and having an inlet connected to the non-thermal plasma reactor exhaust outlet for receiving the plasma treated exhaust stream and an outlet for emitting a catalyst treated exhaust stream.

The present invention employs a small corona discharge ozone generating reactor in conjunction with a non-thermal reactor and using the same electrical connections as the non-thermal plasma reactor but being thermally insulated from the reactor. In an alternate embodiment, the ozone generating device is remotely mounted from the exhaust system. An air pump is used to supply ambient air to the ozone generating device to create ozone which is fed into the diesel exhaust stream upstream of the diesel particulate filter to convert NO in the diesel exhaust into NO₂. The resultant ozone and NO₂ enriched exhaust is then passed through the particulate filter to regenerate the filter.

The ozone generating device may be operated continuously to prevent the buildup of particulate mass on the particulate filter, thus eliminating the danger from heat released during oxidation of the trapped particulate matter in a heavily loaded filter which can damage or melt the filter. In an alternate embodiment, the ozone generating device may be selectively operated to periodically regenerate the filter.

Alternately, the ozone generator may be used in conjunction with a small oxidation catalyst located in front of the particulate filter. In this embodiment the ozone generator can be turned off whenever the exhaust temperature is sufficient for the oxidation catalyst to effect the NO to NO₂ conversion thereby saving electrical energy.

In yet another embodiment, the ozone generating device may be used with a catalyzed particulate filter thereby minimizing the amount of ozone required to maintain the particulate filter in a clean condition.

The present method for concurrently reducing nitrogen oxides and controlling particulate matter in a combustion exhaust stream and regenerating a diesel particulate filter comprises:

passing a combustion exhaust stream including nitrogen oxides and particulate matter through a particulate filter having an inlet for receiving the combustion exhaust stream and an outlet for discharging a particulate treated exhaust stream;

passing the particulate treated exhaust stream through a non-thermal plasma reactor and treating the stream therein, the reactor having an inlet connected to the particulate filter exhaust outlet for receiving the particulate treated exhaust stream and an outlet for discharging a plasma treated exhaust stream; the non-thermal plasma reactor being connected to a high voltage power source;

passing the plasma treated exhaust stream through a catalytic converter having a catalyst for reducing nitrogen oxides in the plasma treated exhaust stream and having an inlet connected to the non-thermal plasma reactor exhaust outlet for receiving the plasma treated exhaust stream and an outlet for emitting a catalyst treated exhaust stream;

providing an ozone generating device having an inlet for receiving a flow of air and an outlet connected to the combustion exhaust stream upstream of the particulate filter; the ozone generating device being connected to the same high voltage power source as the non-thermal plasma reactor;

an air supply for supplying air to the inlet of the ozone generating device;

generating and discharging ozone to the combustion exhaust stream to create an ozone and NO₂ enriched exhaust stream;

passing the ozone and NO₂ enriched exhaust stream through the particulate filter to oxidize particulate matter trapped in the filter thereby regenerating the filter.

In an alternate embodiment, the method further comprises:

passing the combustion exhaust stream through an oxidation catalyst disposed upstream of the diesel particulate filter to provide an NO₂ enriched exhaust stream; and

selectively operating the ozone generating device only when the combustion exhaust stream temperature is insufficient for the oxidation catalyst to effect NO to NO₂ conversion thereby reducing the power consumption of the ozone generating device when the engine exhaust is sufficiently warm.

These and other features and advantages of the invention will be more fully understood from the following description of certain specific embodiments of the invention taken together with the accompanying drawings.

### BRIEF DESCRIPTION OF THE DRAWINGS

Referring now to the drawings, which are meant to be exemplary, not limiting, and wherein like elements are numbered alike:

FIG. 1 is a schematic block diagram of a system for concurrently treating NOx and particulate matter in a combustion exhaust stream in accordance with the present invention.

FIG. 2 is a schematic block diagram of an alternate embodiment of the present system for concurrently treating NOx and particulate matter in a combustion exhaust stream wherein the ozone generating device is mounted remote from the exhaust system.

FIG. 3 is a schematic block diagram of yet another embodiment of the present system wherein a small oxidation catalyst is employed upstream of the diesel particulate filter.

### DESCRIPTION OF THE PREFERRED EMBODIMENT

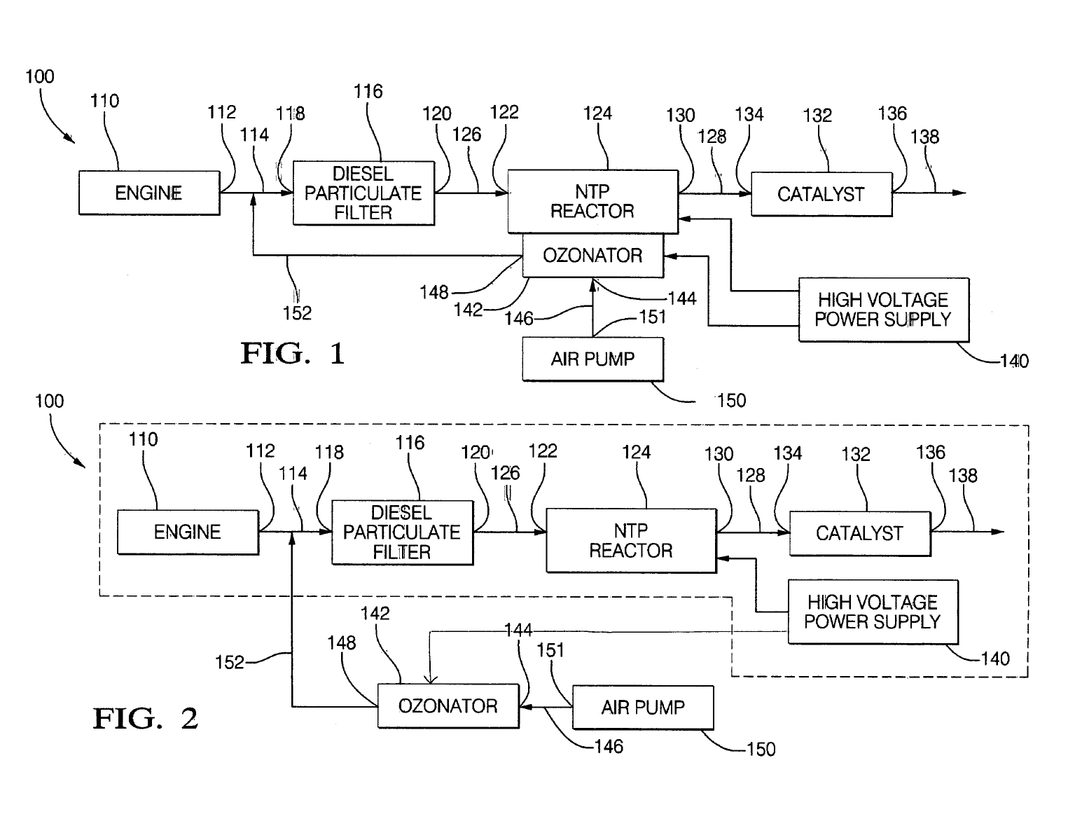

Turning to FIG. 1, a system 100 for concurrently reducing nitrogen oxides from an exhaust stream of a combustion device, controlling particulate matter from the exhaust stream with a particulate filter, and regenerating the particulate filter by oxidizing particulate matter trapped in the particulate filter by feeding the engine exhaust stream with ozone to create NO₂ and passing the ozone and NO₂ enriched exhaust stream through the filter to oxidize particulate matter trapped therein is shown. The present system 100 is not limited for use with a particular combustion device but rather is contemplated for use with a wide variety of combustion devices and processes producing these emissions, for instance, coal- or oil-fired furnaces, reciprocating internal combustion engines (including gasoline spark ignition and diesel engines), gas turbine engines, and so on. However, the system is particularly advantageous for use with a diesel engine.

The embodiment shown in FIG. 1 shows in block schematic form a diesel engine 110 having an exhaust outlet 112 that generates a combustion exhaust stream 114 which includes nitrogen oxides and particulate matter. A diesel particulate filter 116 having an inlet 118 for receiving the combustion exhaust stream 114 is connected to the exhaust outlet 112 of the combustion device 110.

An outlet 120 from the diesel particulate filter is connected to an inlet 122 of a non-thermal plasma reactor 124 for receiving the treated exhaust stream 126 from the outlet 120 of the particulate filter 116. The treated exhaust stream 126 is further treated in the non-thermal plasma reactor 124 primarily to convert nitrogen oxides (NOx) to NO₂.

Although there are several well known non-thermal reactor designs, many of these designs are not able to withstand the wide temperature swings and vibrations associated with a motor vehicle. To properly function in the context of a motor vehicle, a parallel plate, monolithic reactor was developed by the assignee of the present invention. In general, this plasma reactor employs a parallel plate, monolithic structure having a plurality of stacked cells, where each cell includes a plurality of insulating parallel plates that form gas passages therein and at least two electrodes disposed on opposite sides of the parallel plates. Commonly assigned U.S. Pat. No. 6,464,945, issued Oct. 15, 2002, entitled “Non-thermal plasma exhaust NOx reactor” exemplifies one such reactor. Commonly assigned U.S. Pat. No. 6,338,827, issued Jan. 15, 2002, entitled “Stacked shape plasma reactor design for treating auto emissions” is another reactor developed by the assignee of the present invention. The disclosures of the foregoing are hereby incorporated by reference herein in their entireties. The present system is not limited, however, to this particular type of plasma reactor. Rather, it is readily understood that the broader aspects of the present system are applicable to other types and/or configurations for the plasma reactor.

The plasma treated exhaust stream 128 passes from the outlet 130 of the non-thermal plasma reactor 124 to a catalytic converter 132 having a catalyst for further treating the plasma treated exhaust stream 128, particularly for reducing nitrogen oxides in the plasma treated exhaust stream 128. The catalytic converter 132 has an inlet 134 for receiving the plasma treated stream 128 and an outlet 136 for emitting the catalyst treated exhaust stream 138.

The non-thermal plasma reactor 124 is connected to a high voltage power source 140 by suitable electrical connections (not shown) that would be apparent to one of ordinary skill in the art.

A corona discharge ozone generating device 142 having an inlet 144 for receiving a flow of air 146 and an outlet 148 connected to the engine exhaust stream 114 is associated with but thermally insulated by any suitable insulating means from the non-thermal plasma reactor 124. The ozone generating device 148 is connected to the same high voltage power source 140 that serves the non-thermal plasma reactor 124. In FIG. 1, the ozone generating device 142 is disposed proximate to the reactor 124. In an alternate embodiment, as shown in FIG. 2, the ozone generating device 142 may be mounted in a location remote from the exhaust system.

An air supply 150 for supplying a flow of ambient air 146 to the inlet 144 of the ozone generating device 142 preferably includes an air pump 150 having an air outlet 151 for pumping the flow of air 146 into the ozone generating device 148.

The present system 100 employs the small ozone generating reactor 142 in conjunction with a single non-thermal reactor 124 using the same electrical connections 140 as the reactor 124 but being thermally isolated from the reactor 124. In operation, the air pump 150 supplies air 146 to the ozone generating device 142 to create ozone 152 which is fed into the diesel exhaust stream 114 upstream of the diesel particulate filter 116 to convert NO in the diesel exhaust stream 114 into NO₂. The resultant O₃ and NO₂ enriched exhaust is then passed through the particulate filter 116. The ozone generating device 142 may be operated to continuously regenerate the filter 116. Alternately, the ozone generating device 142 may be selectively operated to periodically regenerate the filter 116.

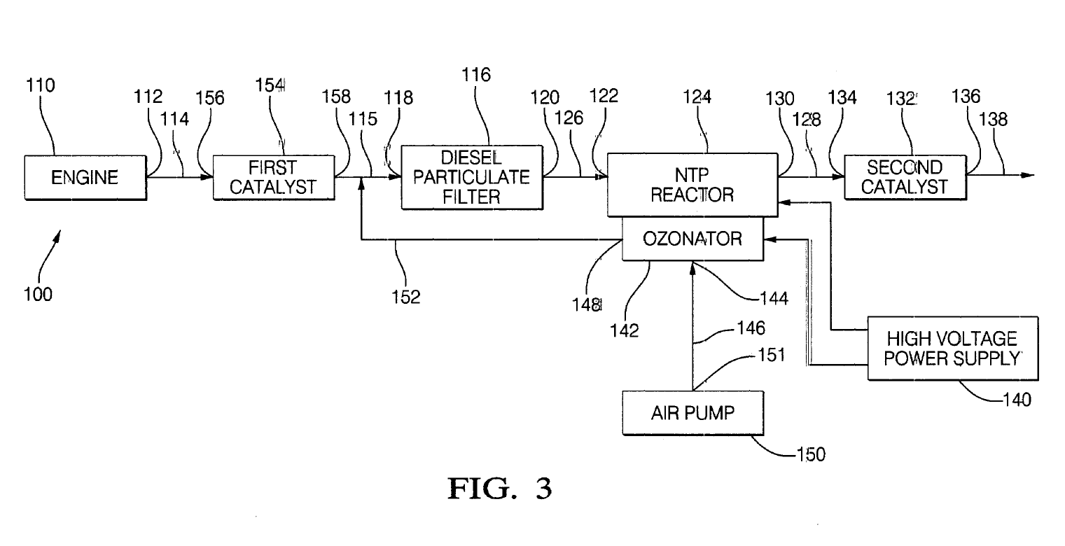

In an alternate embodiment, the ozone generator 142 is used in conjunction with a small oxidation catalyst. In FIG. 3, a first catalyst comprising a small oxidation catalyst 154 having an exhaust inlet 156 and an outlet 158 is disposed between the engine 110 and the diesel particulate filter 116. The engine exhaust 114 flows through the first catalyst comprising small oxidation catalyst 154 and emerges from outlet 158 as first catalyst treated NO₂ enriched exhaust stream 115. The NO₂ enriched exhaust stream 115 is then passed through the particulate filter 116, the non-thermal plasma reactor 124, and the second catalyst 132, finally emerging as catalyst treated exhaust stream 138. In this embodiment, the ozone generator 142 is selectively operated and can be turned off when the engine exhaust temperature is sufficient for the oxidation catalyst to effect the NO to NO₂ conversion thereby saving electrical energy.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A system for concurrently reducing nitrogen oxides and controlling particulate matter in a combustion exhaust stream, said system comprising:
a particulate filter for treating a combustion exhaust including nitrogen oxides and particulate matter, said particulate filter having an inlet for receiving said combustion exhaust stream and an outlet for discharging a particulate treated exhaust stream;
a non-thermal plasma reactor having an inlet connected to said particulate filter outlet for receiving said particulate treated exhaust stream and an outlet for discharging a plasma treated exhaust stream;
said non-thermal plasma reactor being connected to a high voltage power source;
an ozone generating device for generating and discharging ozone to said combustion exhaust stream, said ozone generating device having an inlet for receiving a flow of air and an outlet connected to said combustion exhaust stream;
said ozone generating device being connected to said high voltage power source;
an air supply for supplying air to said inlet of said ozone generating device;
a catalytic converter having a catalyst for reducing nitrogen oxides in said plasma treated exhaust stream and having an inlet connected to said non-thermal plasma reactor exhaust outlet for receiving said plasma treated exhaust stream and an outlet for emitting a catalyst treated exhaust stream.

2. The system of claim 1, wherein said combustion exhaust stream is from a combustion device comprising a coal fired furnace, an oil fired furnace, a reciprocating internal combustion engine, a gasoline spark ignition engine, a diesel engine, or a gas turbine engine.

3. The system of claim 1, wherein said combustion device comprises a diesel engine.

4. The system of claim 1, wherein said ozone generating device is a corona discharge ozone generating device.

5. The system of claim 1, wherein said ozone generating device is disposed proximate to and associated with said non-thermal plasma reactor but thermally insulated from said non-thermal plasma reactor.

6. The system of claim 1, wherein said ozone generating device is remotely mounted.

7. The system of claim 1, wherein said particulate filter comprises a catalyzed particulate filter.

8. The system of claim 1, where said ozone generating device continuously generates and discharges ozone to said combustion exhaust stream.

9. The system of claim 1, where said ozone generating device periodically generates and discharges ozone to said combustion exhaust stream.

10. The system of claim 1, further comprising:
an oxidation catalyst disposed upstream of said diesel particulate filter.

11. A method for concurrently reducing nitrogen oxides and controlling particulate matter in a combustion exhaust stream comprising:
passing a combustion exhaust stream including nitrogen oxides and particulate matter through a particulate filter;
said particulate filter having an inlet for receiving said combustion exhaust stream and an outlet for discharging a particulate treated exhaust stream;
passing said particulate treated exhaust stream through a non-thermal plasma reactor and treating said stream therein, said reactor having an inlet connected to said particulate filter exhaust outlet for receiving said particulate treated exhaust stream and an outlet for discharging a plasma treated exhaust stream;
said non-thermal plasma reactor being connected to a high voltage power source;
passing said plasma treated exhaust stream through a catalytic converter having a catalyst for reducing nitrogen oxides in said plasma treated exhaust stream and having an inlet connected to said non-thermal plasma reactor exhaust outlet for receiving said plasma treated exhaust stream and an outlet for emitting a catalyst treated exhaust stream; and further
providing an ozone generating device, said ozone generating device having an inlet for receiving a flow of air and an outlet connected to said combustion exhaust stream upstream of said particulate filter;
said ozone generating device being connected to said high voltage power source,
an air supply for supplying air to said inlet of said ozone generating device;
generating and discharging ozone to said combustion exhaust stream to create an ozone and NO₂ enriched exhaust stream;
passing said ozone and NO₂ enriched exhaust stream through said particulate filter to oxidize particulate matter trapped in said filter thereby regenerating said filter.

12. The method of claim 11, wherein said combustion exhaust stream is an exhaust stream from a combustion device comprising a coal fired furnace, an oil fired furnace, a reciprocating internal combustion engine, a gasoline spark ignition engine, a diesel engine, or a gas turbine engine.

13. The method of claim 11, wherein said combustion exhaust stream is a diesel engine exhaust stream.

14. The method of claim 11, wherein said ozone generating device is a corona discharge ozone generating device.

15. The method of claim 11, wherein said ozone generating device is disposed proximate to and associated with said non-thermal plasma reactor and also thermally insulated from said non-thermal plasma reactor.

16. The method of claim 11, wherein said ozone generating device is mounted remote from said system.

17. The method of claim 11, wherein said particulate filter comprises a catalyzed particulate filter.

18. The method of claim 11, wherein said generating and discharging ozone to said combustion exhaust stream comprises continuously generating and discharging ozone to said combustion exhaust stream.

19. The method of claim 11, wherein said generating and discharging ozone to said combustion exhaust stream comprises periodically generating and discharging ozone to said combustion exhaust stream.

20. The method of claim 11, further comprising:
passing said combustion exhaust stream through an oxidation catalyst disposed upstream of said diesel particulate filter to provide an NO₂ enriched exhaust stream; and
selectively operating said ozone generating device only when said combustion exhaust stream temperature is insufficient for the oxidation catalyst to effect NO to NO₂ conversion.
